(19) United States
(12) Patent Application Publication
(10) Pub. No.: US 2016/0325901 A1
(43) Pub. Date: Nov. 10, 2016

(54) Accessory Parts Packaging

(71) Applicant: C. & E. Fein GmbH, Schawisch Gmund-Bargau (DE)

(72) Inventors: Isabell Tewes, Schwaebisch Gmuend (DE); Wolfgang Gowohr, Kirchberg/Jagst (DE)

(21) Appl. No.: 15/137,809

(22) Filed: Apr. 25, 2016

(30) Foreign Application Priority Data
May 6, 2015 (DE) 102015107096.0

(51) Int. Cl. B65D 75/36; B25H 3/00; B65D 75/56

(52) U.S. Cl. CPC B65D 75/366; B65D 75/566; B25H 3/006; B65D 2581/00

(57) ABSTRACT

A packaging for holding an accessory part of a tool is disclosed. The tool may have a tool interface for transmitting torque to the accessory part. In an embodiment the packaging includes a first protrusion for engaging in the accessory part and a second protrusion for holding a portion of the accessory part, wherein the first protrusion has in one or more sections or along an entire circumference of the first protrusion a replication of a tool interface as an outer structure, and/or wherein the second protrusion has in one or more sections or along an entire circumference of the second protrusion a replication of the tool interface as an inner structure.

This application claims the benefit of German Application No. 10 2015 107 096.0, filed on May 6, 2015, which application is hereby incorporated herein by reference.

### TECHNICAL FIELD

The present invention relates to a packaging for holding an accessory part of a tool.

### BACKGROUND

In the prior art blister packagings for packaging accessory parts are known. In a blister packaging several accessory parts can be arranged. This allows packaging of each individual accessory to be avoided. Power tools may be in particular hand-held tools, which have a carrying means, for example a handle, with which the power tool can be held by a user, carried and guided during the machining of a workpiece. The power tool has a drive motor, which drives and can provide for example for rotation or oscillation of a drill, grinding or cutting wheel, circular saw, etc. The oscillation may be in particular a rotational oscillation. For connection of the drill, the grinding or cutting wheel or circular saw to the power tool, a tool interface is provided.

### SUMMARY

Blister packagings replicate to a large extent the outer contours of an accessory part to be packaged. This makes blister packagings a very compact packaging for protection against damage to accessory parts. It is advantageous to provide only one type of blister packaging for multiple similar accessory parts of a power tool, such as saw blades, sanding pads, etc. This allows the production and inventory of different blister packagings to be avoided. A disadvantage here may be the lack of adaptation of the blister packaging to the respective accessory part to be packaged, whereby the accessory part may be slipping, twisted and damaged within the blister packaging. A risk of damage exists especially, if several components are arranged within one blister packaging. A plurality of accessory parts can be arranged particularly in a stacked manner within a blister packaging.

Various embodiments provide a blister packaging suitable for multiple different accessory parts of power tools. Various other embodiments reliably prevent slipping of the accessory parts within the blister packaging.

As a first embodiment of the invention, a packaging for holding an accessory part of a tool is provided, wherein the tool has a tool interface for transmitting torque to the accessory part. The packaging comprises a first protrusion for engaging in the accessory part and a second protrusion for holding a portion of the accessory part, wherein the first protrusion has in one or more sections or along an entire circumference of the protrusion a replication of the tool interface as an outer structure and/or the second protrusion has in one or more sections or along an entire circumference of the protrusion a replication of the tool interface as an inner structure.

By forming a replication of the tool interface of the power tool as a contour of the blister packaging, a secure holding of an accessory part to be packaged can be ensured. This prevents a translational movement of the accessory within the blister packaging. In addition, a rotational movement of the accessory part is avoided, since the accessory rests in the replication of the tool interface, which prevents rotation.

Advantageously in the embodiments according to the invention, only few cardboard inserts are required to prevent displacement of the accessory parts to be packaged because by the replication of the tool interface the accessory parts can be prevented from rotating, sliding, turning or shifting.

According to an exemplary embodiment of the invention, a packaging is provided, wherein the replication is a circular or cup-shaped structure with a wave pattern or a star-shaped polygon.

By appropriately forming the protrusion, shifting or rotating the packaged accessory part around the protrusion, which is a replication of the tool interface, can be avoided.

In a further embodiment of the invention a packaging is provided, wherein the packaging has a top side and a bottom side, wherein the first protrusion is arranged on the bottom side and the second protrusion is arranged on the top side.

According to an exemplary embodiment of the invention a packaging is provided, wherein the top side can be pivoted relative to the bottom side in order to reach, in a pivoted state, an enclosure of the accessory part and/or wherein the top side and the bottom side are interconnected.

Pivoting of two corresponding parts allows an enclosure to be achieved easily, wherein the relevant accessory parts are fully protected against environmental influences.

According to a further embodiment of the present invention, a packaging is provided, wherein the packaging is adapted to hold 1, 2, 3, 4, 5, 6, 7, 8, 9, 10 or any number of accessory parts in a stacked manner, wherein a rotation is prevented by the first and/or second protrusion and/or the replication.

A packaging of multiple accessory parts within a single blister packaging allows for an economical way of packaging.

A packaging of the accessory parts according to shape prevents slipping or twisting of the packaged accessory parts. In this way, the risk of damage can be excluded.

In a further embodiment of the invention, a packaging is provided, wherein the first protrusion leads in connection with the second protrusion to a clamping of the accessory part.

By clamping by means of two corresponding protrusions, a “rattling” of the accessory parts can be prevented within the packaging.

According to an exemplary embodiment of the invention a packaging is provided, wherein the tool is an electric power tool or a pneumatic power tool and/or wherein the tool is a hand-held tool.

In a further embodiment of the invention, a packaging is provided wherein in the packaging either a first or a second accessory part may be arranged and/or wherein a plurality of accessory parts can be simultaneously arranged in the packaging, wherein the accessory parts can be identical or different and/or wherein in the packaging either a first or a second number of accessory parts can be arranged.

By providing an “anti-rotation device” by means of the replication of the tool interface, different and/or varying amounts of accessory parts can be arranged in one packaging without having to fear slipping or twisting and mutual damage of the accessory parts.

According to an exemplary embodiment of the invention a packaging is provided, wherein the packaging consists of a plastic material, in particular polyvinyl chloride (PVC), polypropylene (PP), acrylonitrile butadiene styrene (ABS), poly(methyl methacrylate) (PMMA), polyurethane, polyvinyl alcohol or polycarbonate (PC).

In a further embodiment of the invention, a packaging is provided, wherein the packaging is a blister packaging.

According to an exemplary embodiment of the invention a packaging is provided, wherein the replication differs in one or more dimensions by +− 3/10 mm, preferably by +− 5/10 mm, particularly preferably by +−1 mm from the tool interface.

Various embodiments provide forming a blister packaging in such a way that the blister packaging is adapted to the tool interface of a power tool and otherwise creates space for the shape of different accessory parts to be packaged. The accessory parts for a particular power tool may be formed differently according to the tool to be worked on or to the performed activities. However, all accessory parts for a particular power tool have the same shaping for the tool interface of the tool. Therefore, said tool interface can be completely formed by the blister packaging. Further, the accessory parts can be stacked inside the blister packaging by means of said tool interface, wherein slipping is prevented by the shape of the tool interface. Overall, a blister packaging securely avoids slipping of accessory parts, even if different accessory parts are to be packaged.

The individual features can of course also be combined with one another, which in part may also result in advantageous effects beyond the sum of the individual effects.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a blister packaging having a protrusion in a top view, which is formed as a replication of a tool interface,

FIG. 2 shows the blister packaging in a lateral view,

FIG. 3 shows the blister packaging in a bottom view,

FIGS. 4 and 5 show the blister packaging in perspective views,

FIG. 6 shows a top view of the tool interface,

FIG. 7 shows a cross-sectional view of the tool interface, and

FIG. 8 shows a blister packaging having a section showing a sectional replication of the tool interface.

### DETAILED DESCRIPTION OF ILLUSTRATIVE EMBODIMENTS

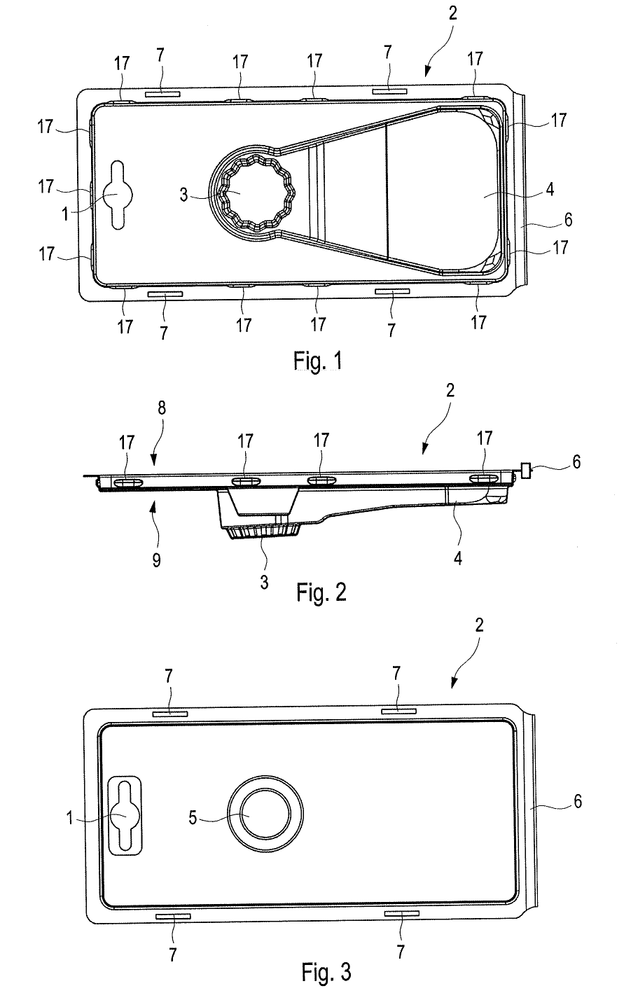

FIG. 1 shows a blister packaging 2 having a cutout for mounting 1. The blister packaging 2 has a protrusion 3, which is formed as a circular structure provided with ripples. Said protrusion 3 corresponds to an exact replication of a tool interface of a power tool, for example an oscillating tool. Further protrusions 4 are shown, which serve a support of accessory parts to be packaged within the packaging 2. Apart from that the blister packaging 2 has free space for holding different accessory parts and any number of accessory parts for power tools having a tool interface with a shape corresponding to the protrusion 3. The blister packaging 2 has a connecting portion 6, which connects a top side 9 and a bottom side 8 of the blister packaging 2. The blister packaging 2 thus comprises the bottom side 8 and the top side 9, wherein the top side 9 is pivotable around the connecting portion 6, whereby the top side 9 can be folded onto the bottom side 8 and can be joined to the bottom side 8 in a detachable manner by locking members 17 and/or welding areas 7.

FIG. 2 shows the blister packaging 2 in a lateral view with the top side 9 and the bottom side 8. The connecting portion 6 is shown, around which the top side 9 and/or the bottom side 8 can be pivoted, so that accessory parts to be packaged can be enclosed.

FIG. 3 shows the blister packaging 2 from below with the recess 5, which transforms into the protrusion 3, on which accessory parts can be arranged in a stacked manner.

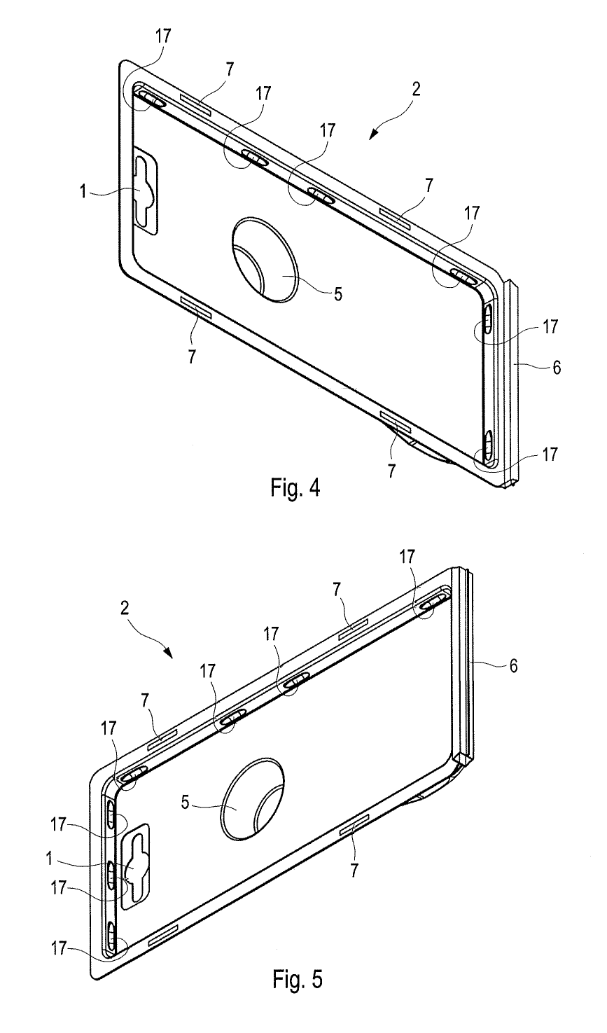

FIGS. 4 and 5 show, in perspective views, the blister packaging 2 with the recess 5, from which the protrusion 3 may arise.

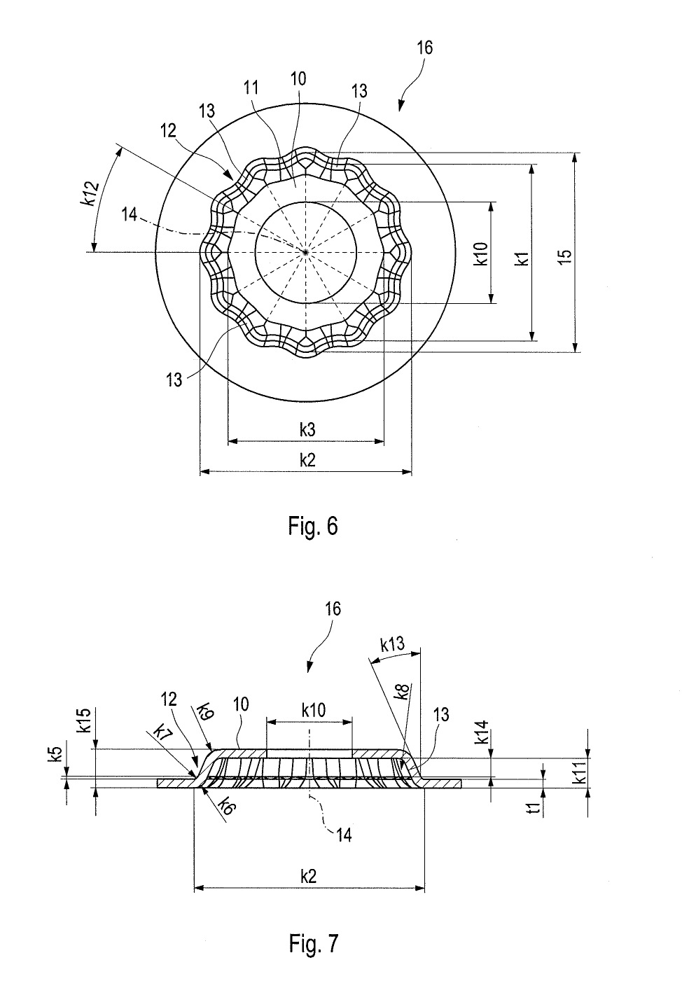

FIG. 6 shows a tool interface 16 in a top view, wherein the tool interface 16 is essentially formed as a star-shaped polygon. The tool interface 16 has a connecting portion 11 as rounded corners.

A so-called arm of the polygon is thereby formed by two drive surface portions 13 and connecting portion 11. The individual arms are each offset against one another by an angle of k12. Preferably this, preferably equidistant, angle k12 results from the correlation: full circle/(number of arms)=k12; present 360°/12=30°. Preferably, due to the equidistant angle k12, it is possible to mount a tool in different rotational positions on the power tool, presently the tool can be offset by discrete steps of 30° with respect to the power tool, particularly an electric power tool (not shown).

An end surface portion 10 is provided, having a, preferably circular, recess with the diameter k10, more preferably shapes differing from the circular shape are possible for said recesses.

Preferably, said recess has an essentially circular shape and can additionally have recesses, which are preferably polygon-like or preferably spline-like and extend preferably radially outward originating from the circular recess. By the use of these recesses this preferably results in a star-shaped polygon with preferably circular sections. Particularly preferably such recesses can be used for tools, which are in particular intended for heavy duty, particularly plunge cut saw blades.

Said recess in the end surface portion 10 is preferably configured so that the tool is held on the power tool, preferably said recess is to be understood as a passage recess/through hole of a mounting device (not shown), in particular a screwing device. Thereby the choice of the diameter k10 can depend on various parameters, preferably on the dimension of the mounting device (not shown) of the power tool. In particular said mounting device is dimensioned in such a way, that the tool is securely held on the power tool.

The diameters k2 and k3 characterize the external diameter of the mounting device. In a preferred embodiment the external diameter k2 is preferably selected in a range between 30 mm and 36 mm, preferably from 32 mm to 34 mm, particularly preferred the external diameter is essentially 33.35 mm (+/−0.1 mm).

In a preferred embodiment the external diameter k3 is preferably selected in a range between 22 mm to 27 mm, preferably from 24 mm to 26 mm, particularly preferred the external diameter k3 is essentially 25 mm (+/−0.1 mm).

The distance k1 defines the distance of two drive surface portions 13, which are in this view parallel and opposite (in a spatial view the drive surface portions 13 are additionally inclined towards each other). Compared to a screw head (such as a hexagonal or square key) the distance k1 corresponds to an across-flats key size.

In a preferred embodiment said across-flats key size k1 is preferably selected in a range between 26 mm and 30 mm, preferably from a range between 27 and 29 mm, particularly preferred the key size is essentially 28.4 mm (+/−0.1 mm).

The diameter 15 indicates a reference diameter for the connecting device 12 of the tool. In a preferred embodiment the reference diameter 15 is preferably selected in a range between 31 mm and 33 mm, preferably from a range between 31.5 mm and 32.5 mm and particularly preferred the reference diameter 15 is essentially 32 mm (+/−0.1 mm). In this case the reference diameter is further preferably characterized in that it is located—viewed in direction of the tool rotational axis 5—essentially at the same height for at least two different tools from a product series of tools (+/−0.1 mm).

FIG. 7 shows the tool interface 16 in a cross-sectional view. In the cross-sectional view the cross-sectional area of the connecting device 12 is particularly apparent. The tool has in the region of its connecting device 12 in a preferred embodiment a, preferably essentially constant, wall thickness t1. More preferably said wall thickness t1 is selected in a range between 0.75 mm and 1.75 mm, preferably from a range between 1 mm to 1.5 mm, and particularly preferably the wall thickness t1 is essentially 1.25 mm (+/−0.1 mm).

It has been found, that a long service ife for the tool interface is especially achievable, if certain transitions on the connecting device 12 of the tool interface 16 are rounded (preferably radii: k6, k7, k8, k9).

In a preferred embodiment at least one of the radii k6, k7, k8 and k9, preferably several, more preferably all, is oriented to the wall thickness t1. Thereby from a greater wall thickness t1 preferably follows an increase of said radii, preferably at least the radii k7 and k9.

In a preferred embodiment (wall thickness t1=1.25 mm) the radius k6 is preferably selected in a range between 1 mm and 2.5 mm, preferably selected in a range between 1.5 mm und 2.1 mm, particularly preferably the radius k6 is essentially 1.8 mm (+/−0.1 mm).

In a preferred embodiment (0=1.25 mm) the radius k7 is preferably selected in a range between 0.5 mm and 1.5 mm, preferably in a range between 0.8 mm and 1.2 mm, particularly preferably the radius k7 is essentially 1 mm (+/−0.1 mm).

In a preferred embodiment (0=1.25 mm) the radius k8 is preferably selected in a range between 0.2 mm and 0.6 mm, preferably in a range between 0.3 mm and 1.5 mm, particularly preferably the radius k8 is essentially 0.4 mm (+/−0.05 mm).

In a preferred embodiment (0=1.25 mm) the radius k9 is preferably selected in a range between 2 mm and 3.5 mm, preferably in a range between 2.4 mm and 3 mm, particularly preferably the radius k9 is essentially 2.7 mm (+/−0.1 mm).

In the drawing of FIG. 7 the drive surface portions 13 are inclined by an angle of k13 with respect to an imaginary vertical line (parallel to the tool rotational axis 14). In a preferred embodiment said angle is selected in a range between 10° and 30°, preferably in a range between 17.5° and 22.5°, and more preferably the angle k13 is essentially 20° (+/−0.5°).

More preferably further dimensions of the tool interface 16 depend on the wall thickness t1, more preferably at least the radii k6, k7, k8 and k9, wherein a greater wall thickness t1 tends to lead to greater radii k6, k7, k8 and k9, preferably at least greater radii k9 and k6.

The diameter k2 preferably characterizes the section of the drive surface portions 13, from which they run rectilinearly. After this straight course the drive surface portions preferably merge into the radius k9 and then into the end surface portion 10.

Preferably the dimension k5 and the radius k7 are dependent from each other. More preferably the dimension k5 is selected in a range between 0.1 mm and 1 mm, preferably in a range between 0.3 mm and 0.7 mm and particularly preferably the dimension k5 is essentially 0.5 mm (+/−0.1 mm).

The radius k6 is preferably located opposite the radius k7 and is greater than said radius. The radii k9 and k8 are also preferably located opposite of each other, more preferably the radius k8 is smaller than the radius k9.

In a preferred embodiment the drive surface portions 13 extend at one height (in direction parallel to the tool rotational axis) essentially rectilinearly at least for the dimension k14, thereby rectilinearly according to the invention is to be understood as said radii having no essential curvature, preferably in an unloaded condition, more preferably in a loaded condition. Preferably the dimension k14 is selected in a range between 1 mm and 3.5 mm, preferably in a range between 1.5 mm and 2.5 mm, more preferably the dimension k14 is to be understood as the shortest rectilinear extension of one of the drive surface portions 13.

The recess in the end surface portion, which is preferably configured to act in combination with the mounting device (not shown) of the power tool (not shown), has the diameter k10. The recess with the diameter k10 is not necessarily a circular recess as shown in FIGS. 6 and 7, rather said recess may, independent of the remaining shape of the tool interface 16, have any other shape (such as a polygon).

In a preferred embodiment the connecting portion 12 has a depth k11, more preferably the depth k11 is selected in a range between 3.5 mm and 6 mm, preferably in a range between 4.5 mm and 5 mm and particularly preferably the depth k11 is essentially 4.7 mm (+0.15 mm).

In a preferred embodiment the connecting portion 12 has a height k15, more preferably the height k15 is selected in a range between 4.5 mm and 7.5 mm, preferably in a range between 5.5 mm and 6.5 mm and particularly preferably the height k15 is essentially 6 mm (+/−0.2 mm).

According to embodiments of the invention in a blister packaging 2, either the bottom side 8 or the top side 9 or the bottom side 8 and the top side 9 replicate the tool interface 16.

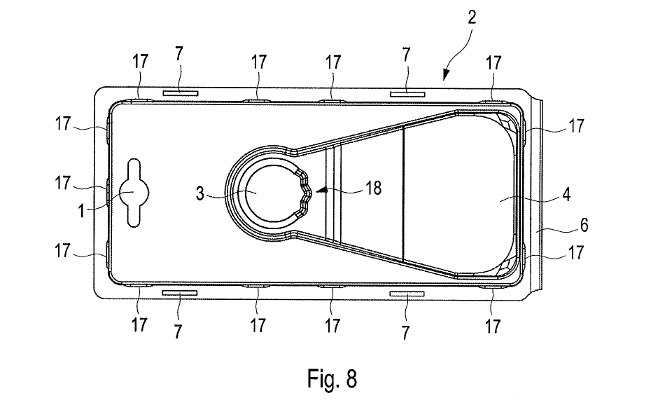

FIG. 8 shows a blister packaging 2 having a protrusion 3, which has only one section 18 as replication of the tool interface 16. In an alternative embodiment the protrusion 3 has multiple sections 18, each replicating corresponding sections of the tool interface 16. This results in the advantage of the embodiments of the invention, that the accessory parts to be packaged can be held stationary and protected against rotation because of the replication of the tool interface and additionally the tool interface with its complicated structure does not have to be replicated along an entire circumference of the protrusion 3.

Embodiments of the invention can in principle be carried out in three basic versions. A protrusion with a replication of the tool interface can be made on the bottom side, wherein the replication is formed as an outer structure. In an alternative embodiment the protrusion with the replication of the tool interface can be arranged on the top side, wherein the replication is formed as an inner structure. In a third version a replication of the tool interface can be formed as an outer structure on a protrusion on the bottom side and simultaneously be formed as an inner structure on a protrusion on the top side. The replication of the tool interface can in each case be arranged along the entire circumference of the protrusion or along a section of the circumference or along multiple sections of the circumference.

The packaging of the accessory parts can be formed as a blister packaging, i.e. as transparent or opaque plastic material, which in its shape in general or in part adapts to the accessory parts to be packaged, or as other packaging, for example made from molded pulp (“egg carton”). The packaging may as a plastic packaging be injected, thermoformed or molded or made from granular material.

The packaging should be suitable for different accessory parts, such that one or multiple similar accessory parts can be arranged in the packaging and/or wherein one or multiple different accessory parts can be arranged simultaneously in the packaging. The packaging is configured in such a way, that in each case an equal number of accessory parts can be arranged or that a different quantity of accessory parts can be arranged.

In an alternative embodiment the bottom side and the top side of the packaging are formed in such a way, that a clamping of the accessory parts is achieved inside the packaging, whereby a “play” of the accessory parts is prevented by the respective replication. This results in a rigid arrangement of the accessory parts inside the packaging.

It should be noted that the term “comprises” does not exclude other elements or steps, just as the term “a” and “one” does not exclude several elements or steps.

The reference numerals used are merely increasing the intelligibility and should by no means be regarded as restrictive, wherein the scope of the invention is represented by the claims.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

### LIST OF REFERENCE NUMERALS

1 cutout for mounting
2 blister packaging
3 protrusion
4 protrusion
5 recess
6 connecting portion
7 welding area
8 bottom side
9 top side
10 end surface portion
11 connecting portion
12 mounting portion
13 drive surface
14 tool rotational axis
15 diameter
16 tool interface
17 locking member
18 section
k1 distance
k2 diameter
k3 diameter
k5 dimension
k6 radius
k7 radius
k8 radius
k9 radius
k10 diameter
k11 depth
k12 angle
k13 angle
k14 dimension
k15 height
t1 wall thickness

What is claimed is:

1. A packaging for holding an accessory part of a tool, wherein the tool has a tool interface for transmitting torque to the accessory part, the packaging comprising:
a first protrusion for engaging in the accessory part; and
a second protrusion for holding a portion of the accessory part,
wherein the first protrusion has in one or more sections or along an entire circumference of the first protrusion a first replication of a tool interface as an outer structure, and/or
wherein the second protrusion has in one or more sections or along an entire circumference of the second protrusion a second replication of the tool interface as an inner structure.

2. The packaging according to claim 1, wherein the first and/or second replication is a circular or cup-shaped structure with a wave pattern or a star-shaped polygon.

3. The packaging according to claim 1, wherein the packaging has a top side and a bottom side, wherein the first protrusion is arranged on the bottom side and the second protrusion is arranged on the top side.

4. The packaging according to claim 3, where the top side is pivotable relative to the bottom side in order to reach, in a pivoted state, an enclosure of the accessory part, and/or wherein the top side and the bottom side are interconnected.

5. The packaging according to claim 1, wherein the packaging is adapted to hold a number of accessory parts in a stacked manner, and wherein a rotation of the accessory parts is prevented by the first and/or second protrusion and/or the first and/or second replication.

6. The packaging according to claim 1, wherein the first protrusion, in connection with the second protrusion, provides a clamping of the accessory part.

7. The packaging according to claim 1, wherein the tool is an electric power tool or a pneumatic power tool, and/or wherein the tool is a hand-held tool.

8. The packaging according to claim 1, wherein, in the packaging, either a first or a second accessory part is arrangeable and/or wherein, in the packaging, a plurality of accessory parts are simultaneously arrangeable, wherein the accessory parts are identical or different, and/or wherein, in the packaging, either a first or a second number of accessory parts are arrangeable.

9. The packaging according to claim 1, wherein the packaging comprises a plastic material.

10. The packaging according to claim 9, wherein the plastic material comprises polyvinyl chloride (PVC), polypropylene (PP), acrylonitrile butadiene styrene (ABS), poly(methyl methacrylate) (PMMA), polyurethane, polyvinyl alcohol or polycarbonate (PC).

11. The packaging according to claim 1, wherein the packaging is a blister packaging.

12. The packaging according to claim 1, wherein the first and/or second replication differs in one or more dimensions by +− 3/10 mm from the tool interface.

13. The packaging according to claim 1, wherein the first and/or second replication differs in one or more dimensions by +− 5/10 mm from the tool interface.

14. The packaging according to claim 1, wherein the first and/or second replication differs in one or more dimensions by +/−1 mm from the tool interface.
